(19) United States
(12) Patent Application Publication
(10) Pub. No.: US 2026/0331644 A1
(43) Pub. Date: Oct. 22, 2026

(54) AQUEOUS ZINC-AIR BATTERIES BEYOND 2V FOR HIGH EFFICIENCY

(71) Applicant: Zhaoyang FAN, Phoenix, AZ (US)

(72) Inventor: Zhaoyang FAN, Phoenix, AZ (US)

(73) Assignee: Arizona Board of Regents on Behalf of Arizona State University, Scottsdale, AZ (US)

(21) Appl. No.: 19/468,524

(22) Filed: Feb. 3, 2026

Related U.S. Application Data
(60) Provisional application No. 63/753,112, filed on Feb. 3, 2025.

(51) Int. Cl. H01M 12/06; H01M 4/24; H01M 50/497

(52) U.S. Cl. CPC H01M 12/06; H01M 4/244; H01M 50/497

(57) ABSTRACT

Embodiments of a decoupled zinc air battery are disclosed. The zinc air battery may include an anode having zinc or a zinc-containing composite, an alkaline anolyte fluidly coupled to the anode, an air cathode having at least one atomic scale catalyst (ASC) dispersed on a titanium-based support where the at least one ASC is configured to catalyze one or both of oxygen reduction reactions (ORR) and oxygen evolution reactions (OER), an acidic catholyte fluidly coupled to the air cathode and a decoupling structure disposed between the alkaline anolyte and the acidic catholyte where the anode and the air cathode are decoupled from one another.

### RELATED APPLICATIONS

This application claims the benefit of U.S. Provisional Patent Application No. 63/753,112, filed Feb. 3, 2025, titled “AQUEOUS ZINC AIR BATTERIES BEYOND 2V FOR HIGH EFFICIENCY,” the entirety of the disclosure of which is hereby incorporated by this reference.

### TECHNICAL FIELD

This document relates to metal-air batteries, including decoupled zinc air batteries and associated materials and methods of manufacture.

### BACKGROUND

Earth abundant zinc can be oxidized by airborne oxygen in water-based electrolytes to generate electricity. This simple, metal-air chemistry positions aqueous zinc-air batteries (ZABs) as an attractive candidate for stationary electrical energy storage. ZABs offer high theoretical energy density, low cost, reliance on earth-abundant and environmentally friendly materials with the safety benefits of aqueous electrolytes. However, conventional alkaline ZABs face challenges to their widespread adoption due to their small energy storage efficiency caused by significant voltage hysteresis between charge and discharge cycles. Considering their typically high coulombic efficiency, their energy efficiency is mainly determined by the charge-discharge roundtrip voltage ratio, which is defined as roundtrip voltage efficiency (η_{V}) at a given charge-discharge current density. As an example, at a current density of 10 mA cm-2, they have a typical charge voltage of ~2 V and discharge voltage of ~1.2 V, resulting in η_{V10} less than 60% at 10 mA cm⁻². To increase the efficiency of ZABs above 75-80%, new battery structure that dramatically increases the open circuit voltage and non-platinum group metals (PGM)-based catalysts that active catalyze oxygen reduction reactions (ORR) and oxygen evolution reactions (OER) in acid are needed.

### SUMMARY

According to some embodiments, a decoupled zinc-air battery includes an anode comprising zinc or a zinc-containing composite. An alkaline anolyte may be fluidly coupled to the anode. In certain embodiments, the battery further includes an air cathode comprising at least one atomic-scale catalyst (ASC) dispersed on a titanium nitride coated support, where the ASC is configured to catalyze oxygen reduction reactions (ORR), oxygen evolution reactions (OER), or both. In some embodiments, an acidic catholyte is fluidly coupled to the air cathode. A decoupling structure may be disposed between the alkaline anolyte and the acidic catholyte such that the anode and the air cathode are decoupled from one another.

In some embodiments, the decoupling structure comprises a bipolar membrane (BPM) including an anion exchange membrane (AEM) fluidly coupled to the alkaline anolyte and a proton exchange membrane (PEM) or a cation exchange membrane (CEM) fluidly coupled to the acidic catholyte, with a catalyst disposed between and fluidly coupled to both membranes. In other embodiments, the decoupling structure comprises a cation exchange membrane (CEM) fluidly coupled to the alkaline anolyte, an anion exchange membrane fluidly coupled to the acidic catholyte, and a neutral aqueous electrolyte disposed between the membranes. In certain embodiments, the neutral aqueous electrolyte comprises potassium sulfate (K₂SO₄). In further embodiments, the decoupling structure includes an AEM and a CEM.

According to some embodiments, the at least one ASC comprises niobium, molybdenum, titanium, vanadium, iron, nickel, or combinations thereof. In certain embodiments, the titanium-based support comprises a titanium foam. In other embodiments, the titanium-based support comprises a titanium nitride (TiN) coating. In some embodiments, the air cathode further includes a gas diffusion layer (GDL) disposed over the TiN coating. In certain forms, a TiN layer is disposed between the titanium-based support and the ASC. In some embodiments, the ASC comprises single atoms, atom clusters, or combinations of single atoms and clusters.

According to additional embodiments, a decoupled zinc-air battery includes an air cathode comprising at least one ASC formed on a nitrogen-doped carbon (NC) or polymeric carbon nitride (PCN) support, where the NC or PCN support is in powder form and the powder is coated onto an acid-tolerant conductive porous structure. In some embodiments, the ASC is configured to catalyze ORR, OER, or both. In certain embodiments, the air cathode is coated with a nanometer-scale TiN coating.

Further embodiments relate to methods of making a decoupled zinc-air battery. In some embodiments, the method includes providing an anode comprising zinc or a zinc-containing composite and providing an alkaline anolyte fluidly coupled to the anode. In certain embodiments, the method includes preparing an air cathode by depositing a titanium nitride (TiN) layer onto a nickel foam substrate and anchoring at least one ASC containing a transition metal selected from niobium, molybdenum, titanium, vanadium, iron, or nickel onto the TiN-coated substrate by impregnation and thermal treatment.

In some embodiments, the TiN layer is deposited onto the nickel foam substrate by plasma-enhanced atomic layer deposition (PE-ALD). In further embodiments, the ASC comprises niobium single atoms anchored to the TiN-coated substrate. In certain embodiments, the impregnation and thermal treatment includes annealing the TiN-coated substrate with a metal precursor at a temperature between 200° C. and 650° C.

In some embodiments, the method includes providing an acidic catholyte fluidly coupled to the air cathode and disposing a decoupling structure between the alkaline anolyte and the acidic catholyte. In certain embodiments, the decoupling structure comprises a BPM including an AEM, a PEM, and a catalyst layer disposed between them. In other embodiments, the decoupling structure comprises a CEM, an AEM, and a neutral aqueous electrolyte comprising potassium sulfate disposed between the membranes. The method may further include assembling the battery such that the anode and the air cathode are decoupled from one another by the decoupling structure. In some embodiments, the method includes coating the air cathode with a gas diffusion layer disposed over the TiN coating.

The foregoing and other aspects, features, and advantages will be apparent from the DESCRIPTION, DRAWINGS, and CLAIMS.

### BRIEF DESCRIPTION OF THE DRAWINGS

Implementations will hereinafter be described in conjunction with the appended and/or included DRAWINGS.

FIG. 1 shows a schematic of a conventional ZAB cell.

FIG. 2 illustrates experimental data of the conventional ZAB cell of FIG. 1.

FIG. 3 shows a simplified Pourbaix diagram of water and zinc.

FIG. 4 schematically shows the effects of decoupling a zinc air battery to increase Voc.

FIG. 5 illustrates the structure of the zinc air battery according to some embodiments decoupled into a zinc half cell and an air half cell.

FIG. 6 illustrates XRD patterns of Ni foam, TiN—Ni foam, and Nb@TiN—Ni foam.

FIG. 7A shows SEM images of Ni foam and TiN—Ni foam.

FIG. 7B shows SEM and BSE images of Nb@TiN—Ni foam.

FIG. 7C shows an EDX spectrum of Nb@TiN—Ni foam.

FIG. 7D shows the corresponding elemental mapping showing Ni (purple), Nb (yellow), Ti (blue), and N (orange).

FIGS. 8A-8F shows a flow for an atomic scale catalyst (ASC) synthesis process using PCN as an exemplary substrate.

FIG. 9A depicts SEM images of a carbon-based support, according to some embodiments.

FIG. 9B depicts AC-STEM-HAADF images of a carbon-based support.

FIG. 9C illustrates XANES spectra of the Nb ASC, according to some embodiments.

FIG. 9D illustrates EXAFS spectra of the Nb ASC, according to some embodiments.

FIG. 10A shows open-circuit voltage profiles of DZABs with Nb-SA@TiN—Ni, Pt—C@TiN—Ni, and Pt—C@Ni air cathodes.

FIG. 10B a full discharge measurement of DZABs with Nb-SA@TiN—Ni, Pt—C@TiN—Ni, and Pt—C@Ni air cathodes.

FIG. 10C shows discharge polarization curves and power density plots for DZABs with different air cathode configurations.

FIG. 10D shows the discharge rate profiles of DZABs with different air-cathode configurations.

FIG. 11A depicts Galvanostatic charge-discharge cycling performance of Nb-SA@TiN—Ni air cathode based DZAB, showing voltage efficiency and overpotential trends.

FIG. 11B depicts cycling performance of Pt—C@TiN—Ni air cathode based DZAB.

FIG. 11C depicts cycling performance of Pt—C@Ni air cathode based DZAB.

FIG. 11D shows the round-trip efficiency at 1 mA cm⁻² for preliminary DZAB.

FIGS. 12A-12C compare the performance of CBA-type DZABs with three different K₂SO₄ buffers: 0.1 M and buffer compartment length 2.5 cm, 0.5 M and buffer compartment length 2.5 cm, and 0.5 M soaked in 0.01 cm thick glass fiber membrane. A) cycling stability at 10 mA cm⁻², B) cycling profiles at 10 mA cm⁻², V_{g10} and η_{V10}, C) cycling profiles at 5 mA cm⁻², V_{g5} and η_{V5}.

FIG. 13 schematically depicts the effects of more efficient ORR/OER catalysts in reducing Vg.

FIG. 14A shows linear sweep voltammetry (LSV) results for ORR for Nb/TIN ASC catalysts in an acid environment.

FIG. 14B shows linear sweep voltammetry (LSV) results for OER for Nb/TIN ASC catalysts in an acid environment.

FIG. 15A shows linear sweep voltammetry (LSV) results for ORR for various catalysts in an alkaline environment.

FIG. 15B shows linear sweep voltammetry (LSV) results for ORR for various catalysts in an alkaline environment.

FIGS. 16A to 16C depict comparison results between an alkaline ZAB cell comprising a Nb ASC and a PGM (Pt/C+IrO2/C) cell at 10 mA cm-2.

FIG. 17A shows performance comparisons between different ASC cells to a PGM (Pt/C+IrO2/C) cell

FIG. 17B illustrates charge-discharge results of an alkaline ZAB cell comprising an ASC of Nb—Mo.

FIGS. 18A and 18D illustrate LSV curves of Nb and Mo based ASCs in acid. FIG. 18A for ORR, FIG. 18B for OER, FIG. 18C for overall ORR+OER curves, and FIG. 18D stability test after 5000 CV cycles.

### DETAILED DESCRIPTION

The following detailed description provides numerous specific details. Those skilled in the relevant arts understand that embodiments of the disclosure may be practiced without these specific details. The disclosure may also be practiced in different and alternative configurations.

Unless specifically noted, it is intended that the words and phrases in the specification and the claims be given their plain, ordinary, and accustomed meaning to those of ordinary skill in the applicable arts. The singular forms “a,” “an,” and “the” include plural referents unless the context clearly dictates otherwise. Thus, for example, a reference to “a step” includes a reference to one or more of such steps. The words “exemplary,” “example,” “embodiment,” or various forms thereof are used herein to mean serving as an example, instance, or illustration. Any aspect or feature described herein as “exemplary” or as an “example” is not necessarily to be construed as preferred or advantageous over other aspects or designs. The examples are provided solely for purposes of clarity and understanding and do not limit or restrict the disclosure. It is to be appreciated that a myriad of additional or alternate examples of varying scope could have been presented, but have been omitted for purposes of brevity.

Throughout the description and claims of this specification, the words “comprise” and “contain” and variations of the words, for example “comprising” and “comprises”, mean “including but not limited to”, and are not intended to (and do not) exclude other components.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one.

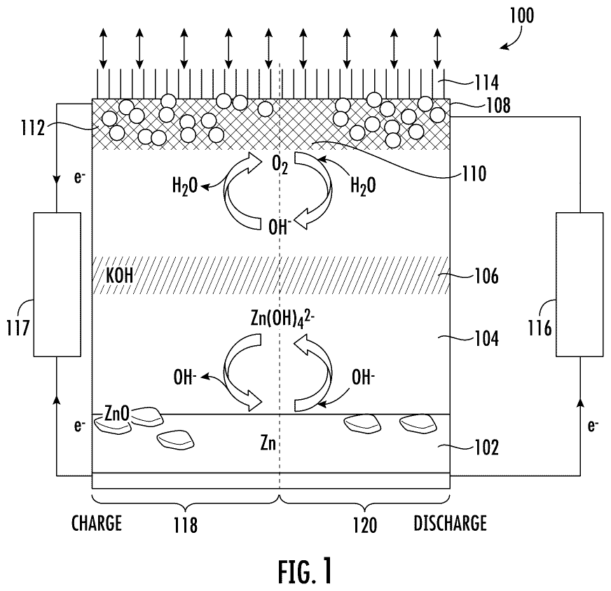

FIG. 1 illustrates a schematic of a conventional zinc air battery (ZAB) 100. ZAB 100 includes a zinc metal anode 102, alkaline electrolyte 104, porous separator 106, and an air-breathing cathode 108. Air-breathing cathode 108 may include ORR/OER catalysts 110, a current collector 112, and a hydrophobic gas diffusion layer (GDL) 114. ZAB 100 supplied current to load 116 during discharge. In charge, power source 117 supply current to ZAB 100. Charge configuration 118 is shown on the left side of ZAB 100 and discharge configuration 120 is shown of right side of ZAB 100. The key reactions during the discharge cycle are detailed below.

Zn electrode:

Zn+40H−=Zn(OH)42−+2e− (Eo=−1.25 V vs. SHE)

Zn(OH)42−=ZnO+H2O+2OH− (after zincate saturation) (1)

Air electrode:

O2+2H2O+4e−=4(OH)− (Eo=+0.40 V vs. SHE) (2)

Overall reaction:

2Zn+O2+2H2O=2Zn(OH)2 (Eocell=1.65 V)

2Zn+O2=2ZnO (3)

This configuration gives a standard cell potential E^{o}_{cell} of 1.65 V. The Nernst equation gives the open-circuit voltage V_{OC} for a cell under nonstandard conditions but mainly depends on the standard cell potential.

The reactions above are reversed when charging ZAB 100. The two half reactions are coupled both spatially and temporally, enabling the transfer of electrons from the anode 102 to the cathode 108 through an external circuit 116 during discharge, while ions move internally through the electrolyte to maintain charge neutrality. This coupling creates a closed current loop, allowing the cell reaction to proceed. While this spatiotemporal coupling is important for the functioning of the cell, it can also lead to challenges. In coupled aqueous batteries, the stable electrochemical stability window of water is only 1.23 V, beyond which water may split into O₂ and H₂ gases. Many strategies to increase the electrochemical stability window of aqueous electrolytes, such as water-in-salt and molecular crowding electrolytes, have been explored, but they come at a high cost and sluggish reaction kinetics.

Conventional zinc-air battery (ZAB) cells face numerous challenges, including slow reaction kinetics for both oxygen reduction (ORR) and oxygen evolution (OER) due to large kinetic barriers, which require catalysts with specific hydrophobic or hydrophilic properties for efficient gas management. These cells also suffer from low discharge voltage, significant voltage hysteresis between charge and discharge, and poor efficiency, primarily caused by ORR/OER overpotentials and low open-circuit voltage. Cycle life is limited by degradation of the zinc electrode—such as ZnO passivation, dendrite formation, and surface instability—and by air electrode issues like carbonate buildup from atmospheric CO₂, ZnO precipitation, and catalyst or substrate corrosion. Water splitting further restricts achievable cell voltage in coupled designs, while the need to use alkaline electrolytes (due to zinc instability in acid) limits catalyst activity, which is generally higher in acidic conditions. Additionally, benchmark catalysts like Pt and IrO₂ are costly and unsustainable for large-scale use, and do not achieve the desired efficiency or voltage gap. Finally, because both ORR and OER occur on the same electrode, there is a need for bifunctional catalysts capable of efficiently catalyzing both reactions.

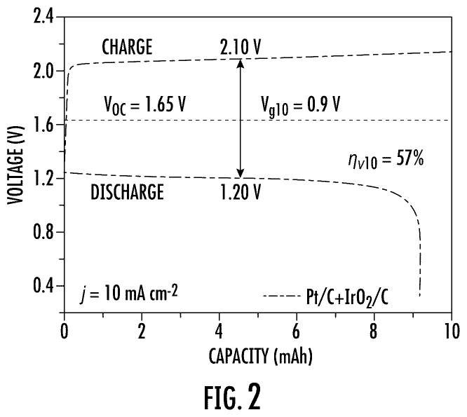

FIG. 2 illustrates experimental data from the conventional ZAB 100 of FIG. 1, using Pt/C+IrO₂/C catalysts. FIG. 2 shows that the voltage output is 1.2 V, Voc is 1.65 V, and η_{V10} is 57%. While many of the challenges facing ZABs stem from ORR/OER kinetics and limitations in catalyst performance, focusing solely on reducing the overpotential (ΔV) may not be sufficient to achieve substantial efficiency gains. Both the open circuit voltage (V_{OC}) and overpotential (ΔV) are important in determining the efficiency, η_{V}. The coupled cell architecture of conventional ZABs, where both anode and cathode share a single alkaline electrolyte, limits the theoretical open-circuit voltage (Voc).

Assuming the same overpotential, ΔV, for both charge and discharge (ΔV=0.5 V_{g}), the efficiency (η_{V}) can be expressed as:

$${η}_{V} = \frac{{V}_{discharge}}{{V}_{charge}} = \frac{{V}_{OC} - Δ V}{{V}_{OC} + Δ V} = \frac{1 - Δ V / {V}_{OC}}{1 + Δ V / {V}_{OC}} \qquad ( 4 )$$

As shown by equation 4, both the open circuit voltage (V_{OC}) and overpotential (ΔV) are important in determining the voltage efficiency, η_{V}. Table I below provides examples to illustrate η_{V} under varying values of V_{OC} and ΔV. For conventional ZABs: V_{OC}=1.65 V and ΔV=0.45 V, η_{V} is 57%.

TABLE I
η_{V10} dependence on V_{OC} & ΔV

| ΔV (V) | Voc = 1.65 V | Voc = 2.60 V |
|---|---|---|
| 0.45 | 57% | 70% |
| 0.40 | 61% | 73% |
| 0.35 | 65% | 76% |
| 0.30 | 69% | 79% |
| 0.25 | 74% | 82% |
| 0.20 | 78% | 86% |
| 0.15 | 83% | 89% |

By increasing the open circuit voltage (V_{OC}) and reducing the overpotential (ΔV), ZABs having increased efficiencies may be realized. Achieving these improvements would enable an operating (discharge) voltage of more than 2 V, bringing ZAB technology significantly closer to practical, high-efficiency applications.

Two main limitations contribute to ZAB inefficiency: 1) the coupled cell architecture, where both anode and cathode share a single alkaline electrolyte, limiting the theoretical open-circuit voltage (V_{OC}), and 2) the lack of effective catalysts for the slow oxygen reduction (ORR) and oxygen evolution reactions (OER) as aforementioned, which results in a high charge-discharge voltage gap.

The limitations to ZAB efficiencies may be addressed by the disclosure herein, including 1) redesigning the battery architecture to a decoupled structure to increase V_{OC}, 2) an air electrode design configured to reduce ohmic and concentration overpotentials, and 3) a bifunctional electrocatalyst to significantly lower activation overpotentials. Combined—a novel cell architecture, an advanced air electrode, and transformative electrocatalysts—are expected to raise ZAB output voltage above 2 V and charge-discharge round-trip efficiency above 80%.

Embodiments of the present disclosure relate to a new battery architecture, a new air electrode design, and new advanced catalyst materials for increasing ZAB output voltage, from under 1.2 V to over 2 V, and improving charge-discharge round-trip efficiency, from under 60% to more than 80%. These advancements significantly improve ZAB performance and mark an important step toward commercialization.

The disclosed decoupled zinc air battery (DZAB) decouples the half reactions at the anode and cathode. By decoupling anode and cathode reactions, the DZAB increases V_{OC} from the current ~1.65 V for traditional ZABs, to above 2 V. In some embodiments, the DZAB uses an alkaline anolyte for the anode and an acidic catholyte for cathode reactions. This approach boosts cell voltage by approximately 0.8 V due to the pH difference and an additional 0.15 V from liquid junction potentials.

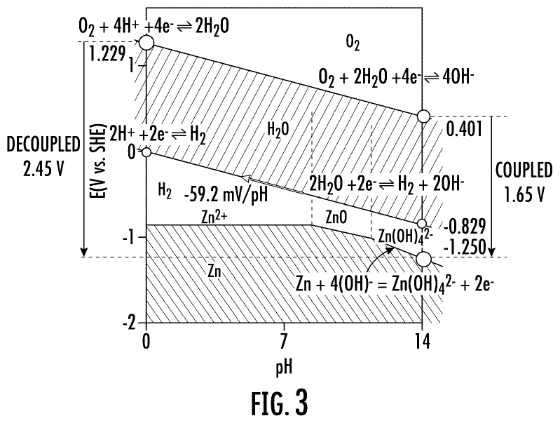

Since zinc metal is unstable in acidic environments, ZABs traditionally use an alkaline electrolyte. As shown in the simplified Pourbaix diagram of FIG. 3, in 1 M KOH, the standard electrode potential (E⁰) at the zinc anode for reaction (1) is −1.25 V vs. SHE, and at the air cathode for reaction (2), it is +0.40 V vs. SHE, resulting in a theoretical V_{OC} of 1.65 V. Decoupling the half-reactions, either spatially or temporally, offers a way to optimize the conditions in each half-cell independently, leveraging the advantages of alkaline and acidic environments simultaneously. Zinc oxidation proceeds effectively in alkaline conditions, while ORR kinetics are faster in acidic media. Decoupling (i.e., separating the anode from the air cathode) allows each half-cell to operate in its optimal pH environment, enhancing overall reaction kinetics and performance.

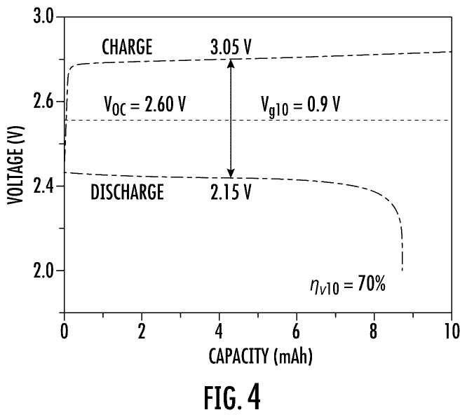

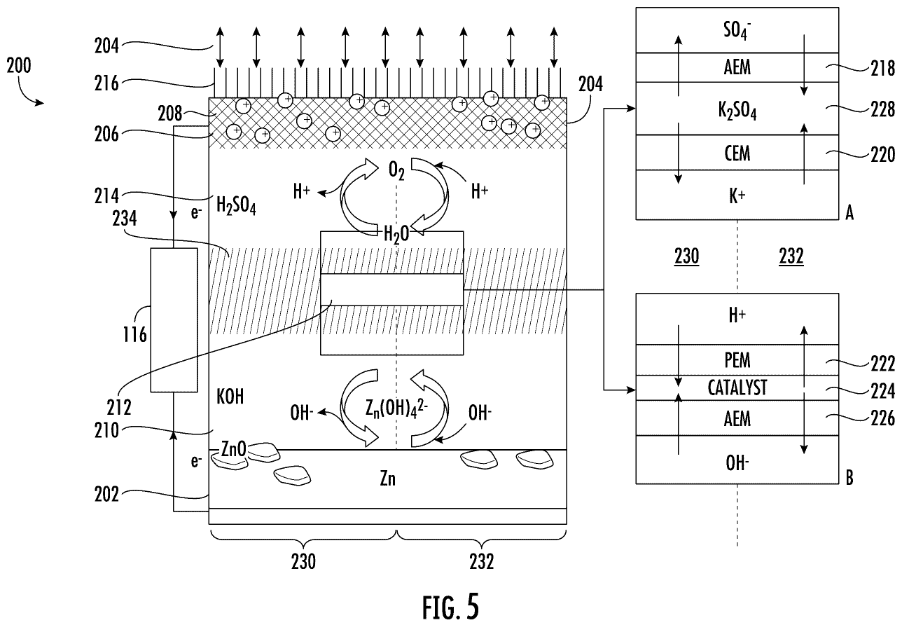

FIG. 4 illustrates where the theoretical V_{OC} has been increased from 1.65 V to 2.60 V using the decoupled ZAB design as disclosed herein. One embodiment of the disclosed decoupled ZAB (DZAB) design is shown in FIG. 5.

FIG. 5 illustrates a DZAB 200, according to some embodiments. DZAB 200 includes a zinc anode 202. Zinc anode 202 may be a foil or porous structure having an alkaline anolyte 210 fluidly coupled to the anode. In some embodiments, zinc anode 202 may comprise a zinc-containing composite. DZAB 200 includes air cathode 204. Air cathode 204 includes an atomic scale catalyst (ASC) 206 disposed on a conductive support 208. ASC 206 is configured to catalyze one or both of oxygen reduction reactions (ORR) and oxygen evolution reactions (OER). DZAB 200 comprises an acidic catholyte 214 fluidly coupled to the air cathode 204, and a decoupling structure 212 disposed between the alkaline anolyte 210 and the acidic catholyte 214 in barrier 234 such that the zinc anode 202 and the air cathode 204 are decoupled from one another. Decoupling structure 212 may comprise a bipolar membrane (BPM) based structure as depicted in FIG. 5B. In some embodiments, decoupling structure 212 is a CBA-based structure (CEM (Cation Exchange Membrane)-buffer-AEM (Anion Exchange Membrane)), as shown in FIG. 5A. Ion flows in charge 230 and in discharge 232 are shown.

DZAB 200 may also include a hydrophobic gas diffusion layer (GDL) 216. The direct exchange of electrolytes or H⁺ and OH⁻ ions between the two half-cells is limited. This reduces the likelihood of water-splitting reactions. Decoupling enables the use of anolyte and catholyte with different pH values or redox mediators. In a DZAB with an acidic catholyte and an alkaline anolyte, the cathode reaction at the air cathode becomes:

O₂+4H⁺+4e⁻=2H₂O (E^{o}=+1.23 V vs. SHE) (5)

This configuration retains the same anode reaction (reaction 1) and overall cell reaction (reaction 3) but increases E^{o}_{cell} to 1.23−(−1.25)=2.48 V, marking a substantial improvement in achievable cell voltage for ZABs.

From the Nernst equation, the Zn electrode potential (reaction (1)) changes with [OH⁻]:

$${E}_{Z {n ( O H )}_{4}^{2 -} / Z n} = {E}^{o} - \frac{R T}{n F} {ln [ {OH}^{-} ]}^{4} = - 1.250 - 0.1184 \times ln [ {OH}^{-} ] \qquad ( 6 )$$

And the air electrode potential (Reaction (5)) changes with [H⁺]:

E_{O}_{₂}_{/H}_{₂}_{O}=1.23+0.059× ln[H⁺] (7)

With the selection of 6M KOH for the anolyte and 3M H₂SO₄ for the catholyte, V_{OC}

is calculated as:

$${V}_{O C} = {E}_{{O}_{2} / {H}_{2} O} - {E}_{Z {n ( O H )}_{4}^{2 -} / Z n} = 2.6 V \qquad ( 8 )$$

For the CBA configuration, the K₂SO₄ concentration and buffer volume are key design parameters. Since ZABs typically begin with discharge, K⁺ and SO₄²⁻ ions will initially move into the buffer. Therefore, the initial K⁺ concentration in the buffer should be lower than that in the anolyte. This lower concentration supports K⁺ and SO₄²⁻ ion movement into the buffer with minimized loss at the CEM and AEM interfaces, but a much lower concentration could increase the resistivity of the buffer compartment. A practical approach is to set the initial K₂SO₄ concentration to be 10-50 times lower than in the anolyte.

This concentration gradient establishes a liquid junction across the CEM, creating a built-in field from the buffer to the anolyte, and another junction across the AEM, forming a field from the catholyte to the buffer. The junction potential can be approximated using the Donnan Equation (9):

$$Δ {E}_{m} = S \frac{R T}{z F} ln ( \frac{{C}_{H}}{{C}_{L}} ) \qquad ( 9 )$$

Where S is ion transfer selectivity (~1), C_{H} and C_{L} are the high and low ion concentrations, respectively, and where R is the Gas Constant, T is absolute temperature, z is Number of Electrons Transferred, and F is Faraday's Constant. For a concentration ratio of 30, ΔEₘ≈87.3 mV at room temperature for each junction, boosting the theoretical V_{OC} above 2.70 V. This junction potential will vary as discharge progresses.

In some embodiments of the decoupled ZAB, the membranes may comprise nonporous membranes useful to separate the anolyte and catholyte into separate compartments fluidly coupled to the anode and cathode, allowing selected ions to pass through the membranes to maintain charge neutrality and creating a continuous ion current pathway between the two electrodes. Various membrane types can be used to form the decoupling structure depending on design requirements. Ion exchange membranes (IEMs) consist of hydrophobic polymer substrates with fixed ion groups and mobile counterions; when hydrated, these groups ionize to enable cation or anion conduction, with perm-selectivity governed by Donnan equilibrium. Cation exchange membranes (CEMs) permit cation passage, while proton exchange membranes (PEMs) are specifically designed for proton transport. Anion exchange membranes (AEMs) allow anion passage, facilitating transport of ions such as OH⁻. Bipolar membranes (BPMs) combine a PEM and an AEM with an intermediate catalyst layer that promotes water dissociation, acting as both a source and drain for H⁺ and OH⁻ ions; catalysts are important in BPMs to minimize overpotential loss. Specific ion selective membranes (ISMs) selectively transport particular ions through alternative mechanisms, such as solid electrolyte membranes that transport Li⁺ but not H⁺, though this approach requires stringent ISM properties.

According to some embodiments, a combination of anion exchange membranes (AEM) 218 and cation exchange membranes (CEM) 220 may be used for the decoupling structure 212, with one membrane 218 stable in acidic conditions and the other 220 stable in alkaline conditions. In some embodiments, the combination of membranes forming the decoupling structure may comprise a pair of CEMs and AEMs. FIG. 5B shows the combination of membranes may comprise a catalyst-embedded BPM (bipolar membrane). In the configuration of FIG. 5A, the AEM 226 faces the Zn compartment and the PEM 222 faces the air compartment. In some embodiments, the BPM-based design may include a catalyst 224 comprising the atomic scale catalyst (ASC) 206 as disclosed herein as a 10-50 nm thick layer with controlled conductivity, which may be deposited on a PEM 222, then bonded to an AEM 226, as illustrated in FIG. 5B. The BPM functions as a source and sink for OH⁻ ions from the anolyte and H⁺ ions from the catholyte, compensating for ion consumption during discharge and ion production during charge.

As a sink, injected H⁺ and OH⁻ ions recombine to form H₂O in the BPM. As a source, H₂O dissociates into H⁺ and OH⁻ ions, with an associated overpotential loss. A catalyst inside the BPM is important to minimize this loss by facilitating efficient water dissociation. Advantages of the BPM-based design include maintaining constant electrolyte composition and pH levels, but may incur voltage losses due to field-driven water dissociation at the membrane interface. The catalyst as shown in FIG. 5B minimizes this dissociation loss.

FIG. 5A shows a combination of membranes with a CBA-based design comprising a CEM 220 and AEM 218 structure. As shown in FIG. 5A, a neutral aqueous electrolyte 228, such as K₂SO₄, may be introduced in the middle buffer compartment between the CEM 220 and AEM 218. In this setup, K⁺ ions act as charge neutralizers for the Zn half-cell, and SO₄²⁻ ions as charge neutralizers for the air half-cell. During discharge, the Zn compartment loses OH⁻ ions, and K⁺ ions move into the buffer. Simultaneously, the air compartment loses H⁺ ions, with SO₄²⁻ ions migrating into the buffer to maintain charge balance. During charging, K⁺ and SO₄²⁻ ions diffuse back to their respective compartments through the CEM 220 and AEM 218, restoring the initial conditions. The CBA-based design may avoid potential losses from water dissociation, as the middle buffer compartment prevents field-driven dissociation.

By decoupling anode and cathode reactions, the proposed DZAB design may increase V_{OC} from ~1.65 V of a conventional ZAB to over 2.6 V.

The disclosed DZAB design can enhance cycle life by leveraging membrane durability and ion selectivity. Decoupling and compartmentalizing the anolyte and catholyte using specialized membranes helps prevent carbonate formation—since the acidic catholyte inhibits CO₂ dissolution—blocks zincate ions from reaching the air electrode to avoid ZnO precipitation, and reduces dendrite formation by containing zincate ions within the zinc compartment. Collectively, these improvements contribute to longer battery life for decoupled ZABs.

In some embodiments, the DZAB cell may comprise a new air electrode design configured to reduce ohmic and concentration overpotentials. The air electrode may comprise a self-supported air electrode to minimize overpotential, having a layered structure designed to optimize oxygen access, catalytic activity, and ion/electron transport. The air electrode may be formed from a corrosion-resistant metal comprising a porous, high surface area metal foam structure which is mechanically robust, anti-corrosive, and suitable for acidic conditions. The air electrode may be designed to efficiently transport electrons, ions, and oxygen to the catalyst sites, thereby reducing both ohmic and concentration overpotentials. The porous, high surface area metal foam structure may be formed from titanium, titanium nitride, alloys of the same, tantalum, Hastelloy, stainless steel, and similar, corrosion-resistant metals. In some embodiments, the metal foam may comprise a 3D porous network to capture the large surface area and interconnected pore structure, which facilitates gas diffusion and electrolyte transport. According to some embodiments, the air electrode may comprise a titanium-based support such as a titanium foam comprising a 3D porous network. In some embodiments, the titanium-based support may have a titanium nitride (TiN) coating or be comprised of TiN. The TiN coating may, in some embodiments have a porous structure. In further embodiments, the TiN coating may be non-crystalline or amorphous, and in additional embodiments, the TiN coating may be both amorphous and porous.

In acidic conditions, titanium (Ti) may be used as a current collector due to its corrosion resistance. TiN offers even greater corrosion resistance and conductivity compared to pure Ti, and may also serve as a current collector. To minimize ohmic, concentration, and activation overpotentials, including issues like gas bubbling, a transformative air electrode structure with two designs or structures further comprising a gas diffusion layer (GDL) is disclosed herein.

A first type of air electrode structure comprises a titanium-based support comprising TiN foam or Ti foam having at least one self-supported high-loading atomic scale catalyst (ASC) directly dispersed thereon. By directly depositing ASCs onto metal foam supports to form self-supported electrodes, this eliminates the need for binders, potentially improving conductivity and stability. In addition to eliminating the need for the polymer binder, the self-supported catalyst structure may enhance structural stability and conductivity, as well as improve mass and electron transport. The high surface area of metal foam further boosts these properties. Use of TiN as the ASC support provides superior conductivity, chemical stability, and corrosion resistance compared to carbon-based supports. The TiN/Ti Foam support structure may be formed by conformally coating a thin layer of TiN onto the internal surfaces of Ti foam using atomic layer deposition (ALD). If needed, plasma etching may be used to modify the TiN surface, creating additional binding sites for anchoring individual metal atoms of the ASC. In some embodiments, the layer of TiN may comprise a partially crystalline structure, an amorphous structure, or combinations thereof.

A second type of air electrode structure comprises high-loading ASCs disposed on a carbon-based support which in some embodiments may comprise a polymeric carbon nitride (PCN), where the carbon-based support has been coated on to a conductive foam. In some embodiments, the conductive foam may comprise TiN foam or Ti Foam. The conductive foam may comprise an additional coating of a conductive layer, such as TiN. According to one embodiment, the carbon-based support comprising PCN may be synthesized by thermally treating melamine and dicyandiamide (7:3 molar ratio), followed by exfoliation. This support can provide up to 40 atom % nitrogen, enabling high ASC loading. The disclosed air electrode structures provide solutions useful in acidic environments. In some embodiments, the carbon-based support comprises an oxygen or nitrogen doped graphitic carbon-based support. During substrate preparation, dopants can be added to modify the electronic properties of both the substrate and the single atom catalyst (SAC), improving catalytic performance by adjusting the adsorption energy of key intermediates. In some embodiments, the innovative air electrode structures can be applied to other metal-air batteries in addition to zinc-air batteries, such as those having an anode comprising lithium, sodium, magnesium, calcium, aluminum and iron.

A stable and integrated binder-free air electrode was designed by depositing a conformal titanium nitride (TiN) layer on nickel foam via plasma-enhanced atomic layer deposition (PE-ALD), followed by anchoring niobium single atoms (Nb SACs) through impregnation and low-temperature annealing. The Nb SACs deliver high oxygen-conversion catalytic activity, while the metallic TiN coating ensures corrosion resistance and mechanical robustness in acidic environments. The resulting 3D porous Nb@TiN—Ni architecture promotes uniform Nb dispersion, efficient charge transfer, and rapid gas/electrolyte transport, leading to excellent durability and round-trip efficiency in asymmetric high-voltage ZABs. The nickel foam was first cleaned with a weak acid solution and ethanol, then dried overnight in a vacuum oven at 80° C.

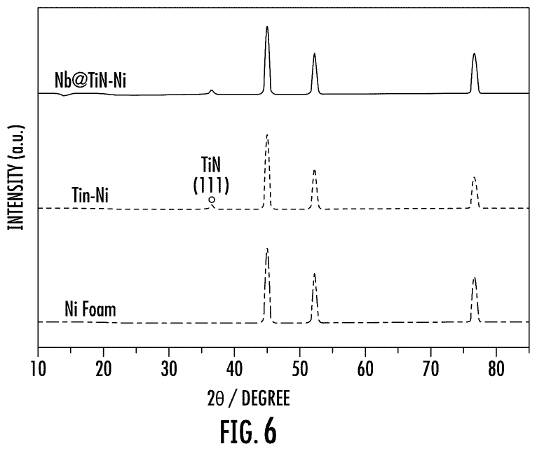

Subsequently, the foam was transferred to the PE-ALD chamber to synthesize TiN—Ni foam, forming a thin and uniform TiN layer on the 3D Ni framework. The structural and morphological characteristics of the prepared samples were analyzed by X-ray diffraction (XRD) and scanning electron microscopy (SEM). As shown in FIG. 6, the XRD patterns of Nb@TiN—Ni, TiN—Ni, and pristine Ni foams were compared. The pristine Ni foam exhibits characteristic diffraction peaks at approximately 44°, 52°, and 76°, corresponding to the (111), (200), and (220) planes of metallic Ni phase (JCPDS No. 04-0850). After the ALD process, these peaks remain dominant, while an additional peak at 36.7° indexed to the (111) plane of TIN (JCPDS No. 38-1420) confirms the successful formation of the face-centered cubic TiN phase. The relatively weak TiN peak intensity indicates the ultrathin nature of the coating. Following Nb single-atom incorporation, no new peaks emerge, suggesting the absence of bulk Nb or Nb nanoparticles.

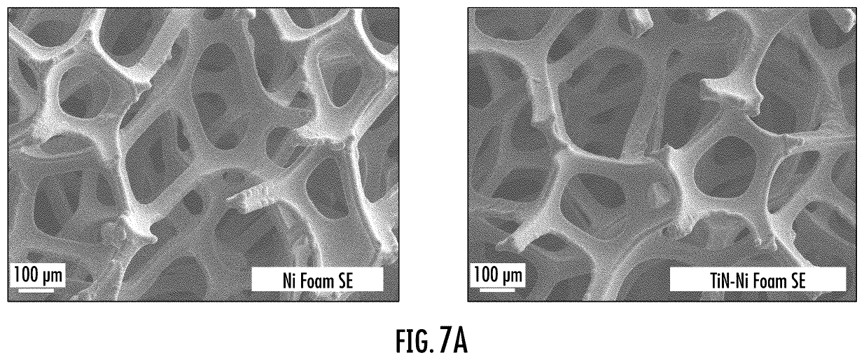

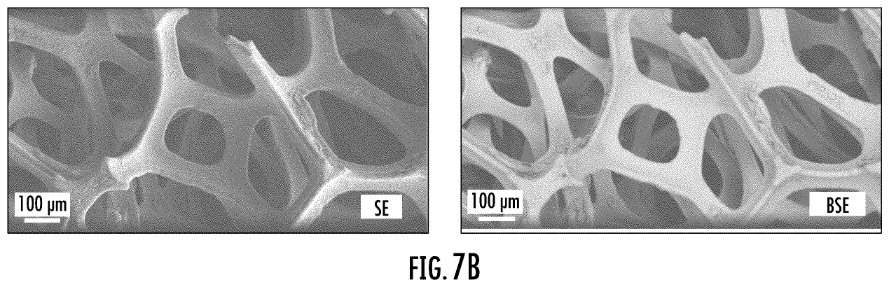

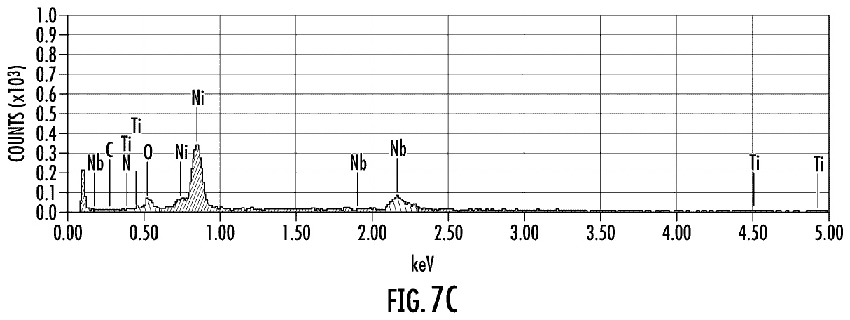

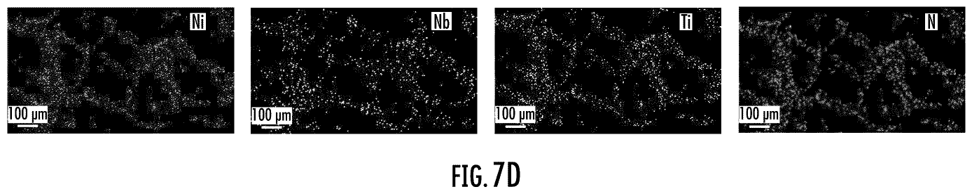

SEM analysis FIGS. 7A and 7B reveals that the pristine Ni foam possesses an open, interconnected 3D porous framework, which remains intact after TiN deposition, demonstrating that the PE-ALD process yields a conformal coating without pore blockage. After Nb incorporation, the Nb@TiN—Ni foam maintains this porous morphology, and no particle aggregation is observed in either SE or BSE images, confirming uniform Nb dispersion on the TIN surface. The EDX spectrum shown in FIG. 7C verifies the coexistence of Ni, Ti, N, and Nb elements, while elemental mapping shown in FIG. 7D demonstrates their homogeneous distribution—Ni (purple), Ti (blue), N (orange), and Nb (yellow)—throughout the 3D scaffold. This uniform atomic dispersion of Nb on the conductive TiN layer ensures the formation of a robust, binder-free electrode with enhanced electronic conductivity and structural stability during long-term operation.

Atomic scale catalysts (ASCs) may have several configurations. Individual metal atoms can be coordinated on N-doped graphitic carbon with each metal atom coordinated with several N atoms, while the N-doped carbon is further coated on Ti foam or TiN coated metal foam. Individual metal atoms may directly be coordinated with N atoms in TiN of the foam without using N-doped carbon. The metal atoms, in addition to coordinating with N atoms in the substrate, also can form axial bonds with O atoms. These metal atom-based catalysts are single atom catalysts (SACs). Advantages of SACs are numerous, including that individual metal atoms which are anchored on substrates or supports allows for precise tuning of catalytic properties through modifications in coordination, substrate doping, bimetallic centers, and other methods. Further, a catalyst effective for one reaction may not favor its reverse due to differing rate-determining steps. Engineering SACs, especially those with dual or multiple metal centers, to function as bifunctional catalysts for both ORR and OER may serve to increase overall reaction kinetics and increase efficiency. The metal atom-based catalysts as disclosed herein may comprise single atom catalysts (SACs). In further embodiments, the metal atom-based catalysts may comprise more than one metal atom, and may comprise bifunctional catalysts. Although SACs are ideal, in reality, metal atoms may form sub-nanometer size clusters, or even small nanoparticles, during the catalyst synthesis. Accordingly, in addition to single atoms, the product may also include sub-nanometer size clusters, nanoparticles, and combinations thereof. The term atomic scale catalysts as used herein is a broad concept intended to include SACs as well as instances where the product includes sub-nanometer size clusters, nanoparticles, and combinations thereof. Despite higher reaction activity in acid compared to alkaline media, acidic ORR and OER catalysts, especially non-platinum group metal (PGM) types, remain limited by stability.

Disclosed herein is a non-platinum group metal (PGM), bifunctional ORR/OER catalyst configured to catalyze both oxygen reduction reaction (ORR) and oxygen evolution reactions (OER). The bifunctional catalyst reduces voltage hysteresis between charge and discharge and may be formed as a self-supporting structure in high density at high loading on a surface of the disclosed air electrode structures. The bifunctional multi-metal catalysts may catalyze both ORR and OER and may be designed for use in both alkaline and acidic environments, significantly lowering activation overpotentials.

According to some embodiments, the bifunctional multi-metal catalysts may comprise niobium (Nb), molybdenum (Mo), titanium (Ti), vanadium (V), iron (Fe), nickel (Ni), or combinations thereof. Other metals may also be used. In particular embodiments, the bifunctional multi-metal catalysts may comprise Nb, Mo, or varying combinations thereof. In some embodiments, the catalysts may rely on or embody any of the principles discussed in U.S. Provisional Application No. 63/710,535, which is incorporated herein in its entirety by reference. Catalytic effectiveness relies on moderate binding between metal sites and redox intermediates. While weak binding limits catalytic activity, overly strong binding hampers intermediate removal, increasing the energy barrier. Tuning the electronic structure of the metal sites can optimize binding strength, leading to improved catalyst performance. Regulation of the electronic structure of metal centers in ASCs may be done by modifying support, coordinating environments, axial bonding, etc. to optimize catalytic activity.

An ASC comprising Nb was disposed on an N-doped graphitic carbon (NC) support. After synthesis, the SACs can be treated with O- and S-containing compounds to form axial M=O or M-S bonds. An oxo ligand (O²⁻) can enhance OER activity by facilitating oxygen adsorption. The M-S bond improves the electronic structure for ORR by altering the metal atom's electron density. The NC support was formed from a method using impregnation and pyrolysis with glucose (C₆H₁₂O₆) as carbon precursor and NbCl₅ as Nb precursor. Unlike the common practice of pyrolysis at high temperatures (>800° C.), in the disclosed method pyrolysis was conducted at 600° C. The produced NC comprises (O, N)-doped carbon, and Nb atoms which are bonded with both O and N. ASCs comprising Fe, Mo and Nb—Mo were synthesized in a similar manner.

Niobium based catalyst is synthesized using a controlled process involving impregnation and pyrolysis. In a typical recipe, 288 mg of glucose (C₆H₁₂O₆) was dissolved in 80 ml of ethanol as carbon precursor. Simultaneously, 10 mg of Niobium (V) chloride (NbCl₅) was ultrasonically dissolved with 1.38 g of hydroxylamine hydrochloride ((NH₃OH)Cl) in 80 ml of deionized water to serve as the metal salt precursor. The two solutions were then mixed, and dried in an oven at 70° C. for 12 h to remove solvents and facilitate the formation of a stable precursor material. Following drying, the mixture was transferred to a crucible and subjected to pyrolysis. The temperature gradually increased from room temperature to 600° C. at a rate of 5° C./min under an argon (Ar) atmosphere. The mixture was maintained at 600° C. for 4 h to complete the pyrolysis process. The obtained powder, consisting of atomically dispersed niobium anchored on N-doped graphitic carbon (NC) are denoted as Nb-SA/NC or Nb—NO—C, and the bare reference sample NC is prepared using the same procedure without adding NbCl₅ salt. It is noted in the synthesized N-doped graphitic carbon, in addition to nitrogen element, oxygen impurities generally also exist. The concentration of these impurities depends on the precursor pyrolysis temperature and process duration. The single metal atoms are considered to be anchored on the graphitic carbon through bonding formation between each single metal atom and its direct neighboring nitrogen element in the graphitic carbon. Since O element also exists in the low temperature synthesized carbon material, the bonding between metal atoms and O atoms cannot be excluded. Furthermore, the metal atom may also form new bonds with ambient oxygen. Therefore, this category materials are given a generic name of Nb—NO—C, suggesting that individual Nb atom bonds with N and/or O as its nearest neighbors. One possible configuration is O—Nb—N4.

Individual metal atoms have the tendency to diffuse on a support surface and aggregate into clusters and particles when they have enough thermal energy at high temperatures. When carbonization temperature is high, the N impurities in the formed carbon will be reduced, while a high concentration of N in carbon is critical to achieve a large SAC density Therefore, the precursor pyrolysis (carbonization) temperature is quite low. However, a low carbonization temperature is detrimental to carbon conductivity, negatively impacting the electrocatalyst performance.

Two-step method is used to increase single metal atom density: synthesize NC first at a higher temperature and then synthesize single metal atoms on NC at lower temperatures. When nitrogen atom concentration is comparable to carbon atom, the material should be called carbon nitride, and most commonly, pyrolysis derived carbon nitrides are called polymeric carbon nitrides (PCN), of which, the basic building block is often a triazine (C₃N₃) or heptazine (C₆N₇) ring, where carbon and nitrogen atoms form a cyclic structure. These rings can link together through C—N bonds to form an extended two-dimensional or three-dimensional network.

Synthesizing Polymeric Carbon Nitride (PCN) typically involves thermal polymerization of nitrogen-rich precursors like melamine, dicyandiamide, urea, or cyanamide. These precursors undergo condensation reactions when heated, leading to the formation of a polymeric network of carbon and nitrogen atoms. The recipe of PCN synthesis consists of: 1) take a given amount of precursor like melamine, dicyandiamide, urea, or cyanamide, or their mixture in certain ratio such as melamine and dicyandiamide (7:3 molar ratio), load into a crucible with a lid to create a semi-closed environment (to maintain a slight pressure during polymerization), heat the crucible in a tube furnace under an inert atmosphere (e.g., argon or nitrogen) at a ramp rate of 5-10° C./min, raise the temperature to 550-600° C. and hold for 2-4 hours, allow the furnace to cool to room temperature naturally. The resulting yellow powder is PCN.

The as-synthesized PCN can be further functionally modified by acid treatment. Typically, the obtained PCN powder is treated with 65 wt % nitric acid (HNO₃) at 80° C. for 5-6 hours. This acid treatment can introduce oxygen-containing functional groups (e.g., —OH, —NO₂) onto the surface of the carbon nitride, which can improve its relevant properties for specific applications. Acid treatment can also remove impurities and create pores in the material, enhancing its surface area and reactivity. As a last treatment, the PCN is ultrasonic treated to achieve well-dispersed suspension and remove any agglomerations. They are collected and dried to get PCN powder.

Synthesis of Nb—NO—C. An impregnation-pyrolysis method is used with PCN as the NC substrate for the synthesis. A proper metal salt is selected as the metal precursor that should decompose at the pyrolysis temperature, 400-500 C to get the metal atoms with other elements vaporized. For Nb, niobium oxalate, a complex of niobium with oxalate anions (C₂O₄²⁻), and its pyrolysis temperature is 400 C. In one recipe, 2.5 g of PCN is added in 50 ml of a 0.10-0.15 mol/L niobium oxalate solution to make a suspension, which is treated by ultrasonic to become homogeneous. The suspension is aged at room temperature for 2 hours, and then dried at 80° C. overnight. The well-impregnated powder mixture is loaded in a tube furnace. After purging with N₂ or Ar, the tube furnace is pumped down to a low pressure of below ~1 mtorr. The furnace temperature is increased from room temperature to 400° C. at a rate of 5° C./min in vacuum. Then pyrolysis under vacuum conditions at 400° C. lasts for 1 hour. The black powder Nb SA/NC was obtained.

These ASC on carbon substrates are powders that may be coated on a current collector of the air electrode. The current collector may comprise an acid-tolerant, electrically conductive, porous structure such as carbon cloth or metal foams (e.g., a TiN/Ti metal foam). For using in acidic catholyte, Ti foam or TiN coated metal foam is a good option. The ASC/C powder with a mass loading of 1 mg cm⁻² is coated on the foam through slurry coating with a binder. To reduce the interface resistance, the metal foam can be coated with a thin layer of carbon first.

In contrast to binder-assisted slurry coating of prefabricated ASC/C catalysts, the individual metal atoms can also be directly coordinated on TiN surface of the metal foam without using N-containing carbon powder as the substrate. In this case, the TiN-coated metal foam is dip-coated with metal catalyst precursor solution and then thermally processed to synthesize ASC/TiN with atomically dispersed metal atoms coordinated with N in TiN.

Disclosed is a method of forming an air electrode as part of a decoupled metal air battery. The method includes providing a conductive support to act as a current collector. According to an embodiment, the conductive support may comprise a metal foam conductive support. The metal foam support may comprise a corrosion resistant, conductive metal such as Ti or TiN and combinations thereof. According to some embodiments, the method further includes coating the conductive support with a conductive coating or layer. The conductive coating may comprise a metal nitride, such as TiN or similar, conductive nitrides, and combinations of the same. In some embodiments, the conductive coating or layer comprises a porous coating on the support, such as a porous TiN coating. In some embodiments, carbon-based supports (e.g., NC or PCN powder) are used with the atomic scale catalyst (ASC) formed thereon. The ASC formed on the carbon-based support, such as NC and PCN, may be a powder. The powder, through a proton conductive polymer binder such as Nafion, PTFE, and PVDF, may be coated on a porous structure (e.g., carbon cloth or metal foam) that acts as the current collector. This catalyst loaded structure is hydrophilic. In some embodiments, the catalyst-loaded structure is stacked with by a hydrophobic gas diffusion layer (GDL), as depicted in FIG. 5, to form the air electrode.

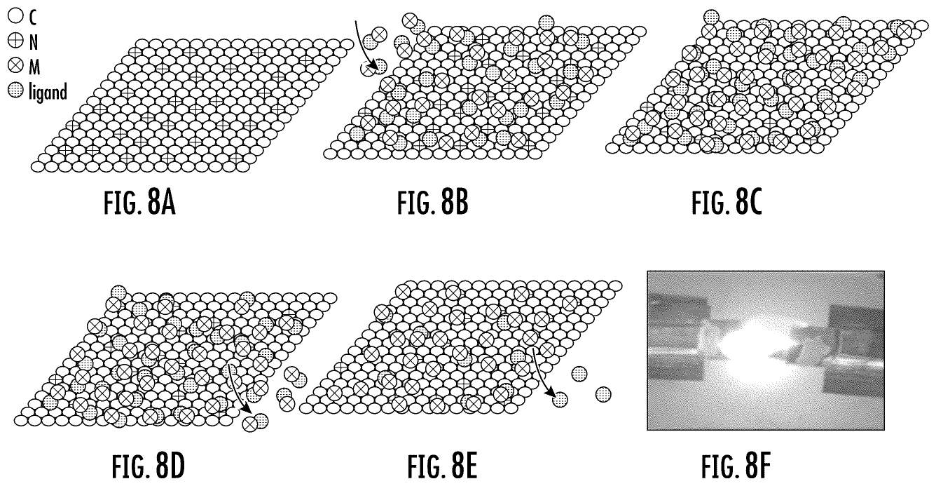

FIGS. 8A-8E schematically show the strategy to synthesize ASCs on PCN substrate (FIG. 8A). Similar method can be used to synthesize ASCs on TiN surface. Distributing the ASC over the conductive coating on the support may be done using a metal precursor and wet chemistry techniques to impregnate the substrate with the metal precursor, as shown in FIG. 8B. In order to induce metal atom migration across the surface and anchor at coordination sites on the support, the method includes thermally treating the mixture as shown in FIG. 8C at a temperature which is high enough to cause metal precursor migration, yet low enough to prevent premature decomposition of the precursor that will lead to metal aggregation. The temperature may be selected dependent upon the ligands present in the precursor by using techniques such as thermogravimetric analysis (TGA) which may be used to detect mass loss, confirming when the ligands have evaporated and at what temperature the decomposition of the precursor is complete.

Central to the method is surrounding each individual metal atom, or atomically dispersed clusters of atoms, by its ligands, thereby preventing metal aggregation and/or large scale metal clustering. Thermally driven migration and anchoring can be used to control how the metal atom is coordinated to the substrate.

The ASC sites may be isolated, single metal atom and/or atomically dispersed clusters of atoms, comprising isolated catalytic sites disposed on a surface of the TiN coating or foam, having a high density of single-atom active centers. Single metal atoms may anchor on TIN surfaces by binding to N or Ti vacancies within the TiN lattice. In some embodiments, thermally treating the conductive support may be done at about 200° C.-300° C., or about 200° C.-250° C. As used herein, “about” or “substantially” means a percent difference less than or equal to 20% difference, 10% difference, or 5% difference.

Thereafter, excess metal precursors may be removed from the surface of the conductive support by a washing or flushing step, as shown in FIG. 8D to remove excess precursors. After the metal atoms, or atomically dispersed clusters of atoms, are anchored at their intended coordination sites on the conductive support, the ligands are evaporated, leaving the metal atoms immobilized. To evaporate the metal precursor ligands, higher temperatures of 400-600° C. are applied for about 1 hour. The temperature and duration are selected to be sufficiently high and long enough to promote ligand evaporation while avoiding metal atom accumulation. Flashing heating is an alternative process. FIG. 8E illustrates flash heating or joule heating of the conductive support at high temperatures for a short duration, such as for 10 seconds or less. Flash heating or joule heating provides decomposition of metal precursors and evaporation of any ligands, leaving behind atomically dispersed metal atoms, or atomically dispersed clusters of atoms, coordinated with nitrogen atoms on the substrate (e.g., a PCN conductive support, a TiN-coated metal foam conductive support, etc.).

The joule heating also enhances conductivity while retaining nitrogen coordination sites in the PCN conductive support. In embodiments where the conductive support comprises the first type of air electrode comprising a metallic foam substrate such as titanium, similar steps as shown in FIGS. 8A-8F may be followed. FIG. 8F illustrates the flash heating process in progress. By carefully adjusting the temperature and duration of the flash heating step, the degree of reduction or oxidation of the metal atom may be controlled, and the formation of M-N bonds may be regulated, thereby tuning the electronic structure to favor either ORR or OER. The rapid flash or joule heating process minimizes or prevents metal atom aggregation on either type of air electrode structures.

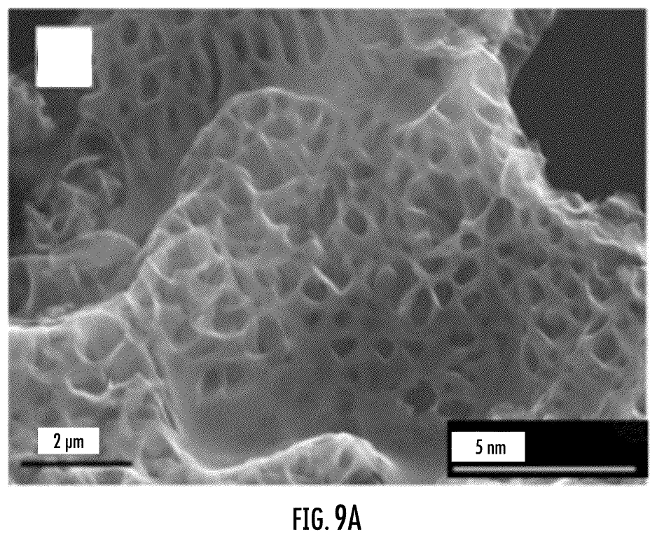

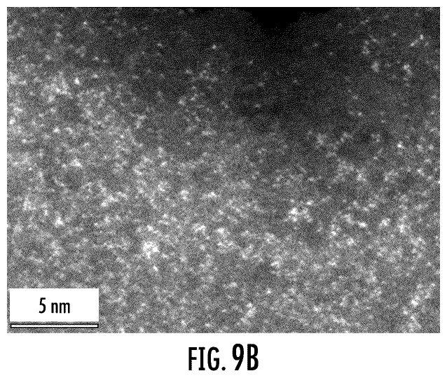

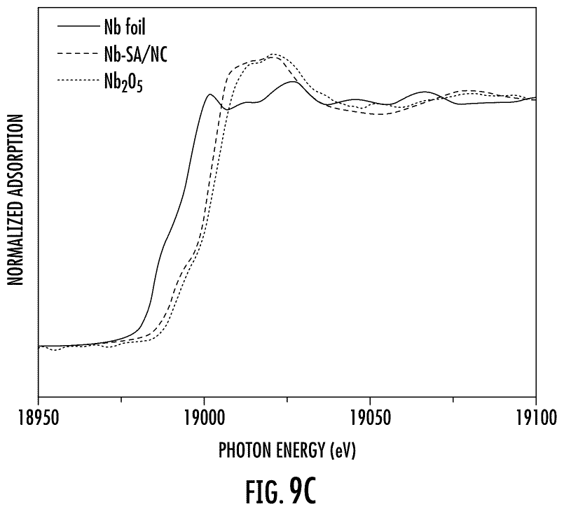

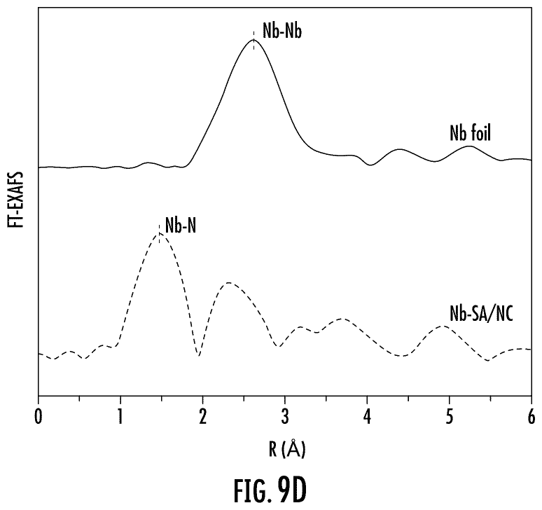

The NC support features a hierarchical porous structure (as shown by the SEM image of FIG. 9A) showing dispersion and spatial distribution of individual Nb metal atoms on the carbon-based support. The carbon-based support provides abundant transport channels for O₂ diffusion and electrolyte infiltration, along with numerous active catalytic sites. The catalysts may be distributed at an individual atomic scale or in atomically dispersed clusters, (rather than solid clusters or nanoparticles) as depicted in the atomic resolution AC-STEM-HAADF image of FIG. 9B showing the dispersion and spatial distribution of individual Nb metal atoms on the carbon/NC support, forming a Nb ASC. As depicted in FIG. 9B, some Nb atoms form atomically dispersed clusters (rather than solid clusters or nanoparticles), while some Nb atoms are individually dispersed on the carbon-based support. As may be seen in FIG. 9B, in some embodiments, the atomically dispersed clusters may be about 10 nm or less in greatest dimension, down to a size of an individually dispersed Nb atom. The carbon-based support as shown in FIGS. 9A-9B may comprise a portion of the second type of air electrode structure, where the carbon-based support may be coated with a titanium foam, a titanium nitride (TiN) foam, or combinations thereof. In some embodiments, the carbon-based support may comprise a titanium foam comprising a porous TiN coating. The first type of air electrode structure may be similarly coated as described above for the second type of air electrode.

In the X-ray absorption near-edge spectroscopy (XANES) of FIG. 9C, a shift in the absorption edge for Nb ASC to a higher energy level as compared to that of Nb-foil and indicates an increase in the oxidation state of Nb. The Fourier-transform extended X-ray absorption fine structure (FT-EXAFS) spectrum of the Nb K-edge (FIG. 9D) provides insights into the local coordination environment of the Nb atoms, with no characteristic Nb—Nb bond signals detected, confirming that Nb atoms are atomically dispersed, whether as single atoms or as atomically dispersed clusters.

For large-scale applications, achieving 100% single dispersed atoms is challenging, and the atomic-scale catalysts (ASCs) as disclosed herein may comprise both single atoms and fine clusters. The presence of fine scale clusters alongside single atoms within the catalyst can lead to synergistic effects, potentially enhancing catalytic performance beyond that of pure SACs. In addition, dual- or multi-metal centers can introduce synergistic effects between the metal centers that may enhance catalytic performance.

The atomic scale catalysts as disclosed herein may be distributed onto the support of the air electrodes with a mass loading of from 0.1 to 10 mg cm⁻². A single atom concentration may be from about 0.1 atom nm⁻² to about 5 atom nm⁻², or about 2 atom nm⁻². Atomic scale catalysts formed having catalysts within these concentrations may improve catalytic performance and reduce Vg.

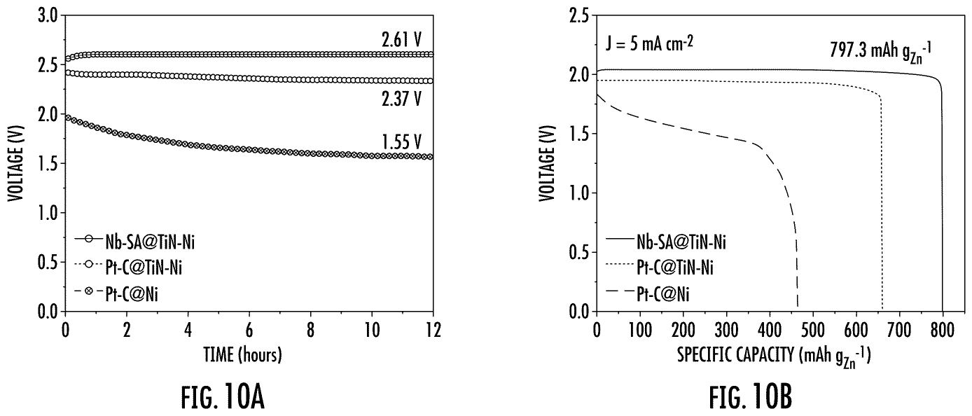

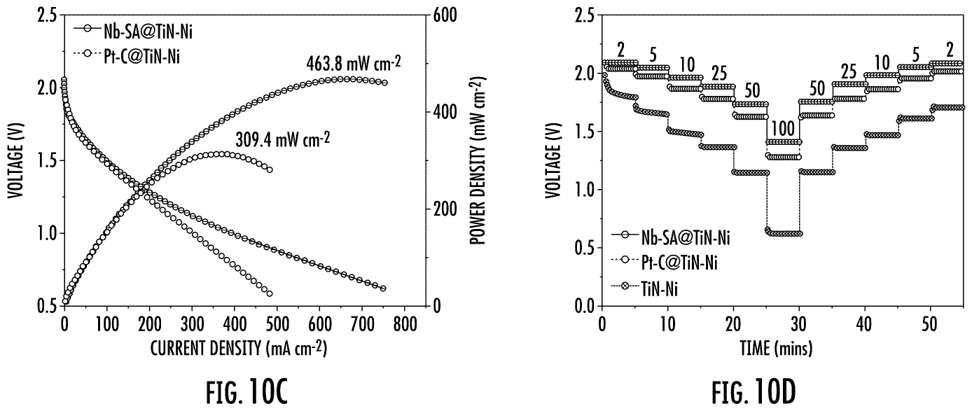

The electrochemical performance of the high-voltage decoupled (or asymmetric) zinc-air batteries (DZABs) was evaluated using a configuration of Air cathode | 3 M H₂SO₄| AEM | 0.1 M K₂SO₄| PEM | 6.0 M KOH+0.2 M Zn(CH₃COO)₂, with a polished zinc plate serving as the anode. For comparison, DZABs assembled with commercial Pt—C catalysts were also tested under identical conditions. As shown in FIG. 10A, the Nb-SA@TiN—Ni-based DZAB exhibited a high open-circuit voltage (OCV) of approximately 2.61 V, surpassing that of the Pt—C based AZAB (2.37 V), which can be attributed to reduced internal impedance and improved charge transfer kinetics. In contrast, the DZAB assembled with pristine Ni foam displayed a rapid decline in OCV due to severe corrosion and structural degradation in acidic media, highlighting the critical protective role of the TiN conductive coating. Galvanostatic discharge profiles at a constant current density of 5 mA cm⁻² (FIG. 10B) demonstrate a specific capacity of 797.3 mAh gzn⁻¹ for the Nb-SA@TiN—Ni electrode, significantly higher than that of the Pt—C based DZAB (652.8 mAh gzn⁻¹). As shown in FIG. 10C, the Nb-SA@TiN—Ni based cell delivers a maximum power density of 463.8 mW cm⁻² at 675.3 mA cm⁻². This value notably exceeds that of Pt—C (309.4 mW cm⁻² at 372.1 mA cm⁻²) and surpasses many previously reported ZAB systems employing single alkaline electrolytes. The reduced polarization and higher power output confirm the superior oxygen redox kinetics of the Nb single-atom catalyst in acidic environments, leading to a more positive air-cathode potential. The rate performance further demonstrates the robust electrocatalytic capability of the Nb-SA@TiN—Ni electrode (FIG. 10D). It delivers higher discharge voltage plateaus than Pt—C across a wide current range (2-100 mA cm⁻²). Moreover, the TiN layer (~20 nm) effectively prevents corrosion in acidic media while preserving metallic conductivity and providing abundant nitrogen sites for Nb atom anchoring.

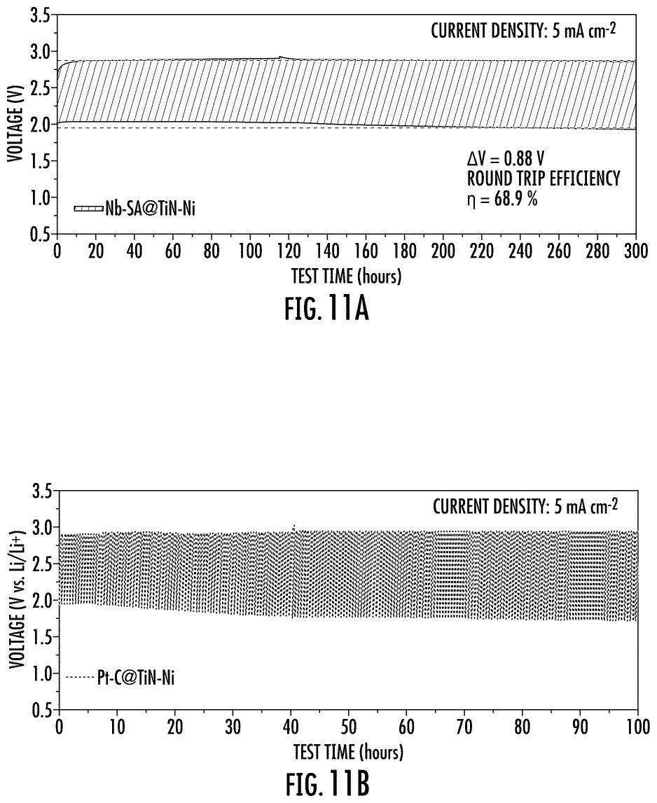

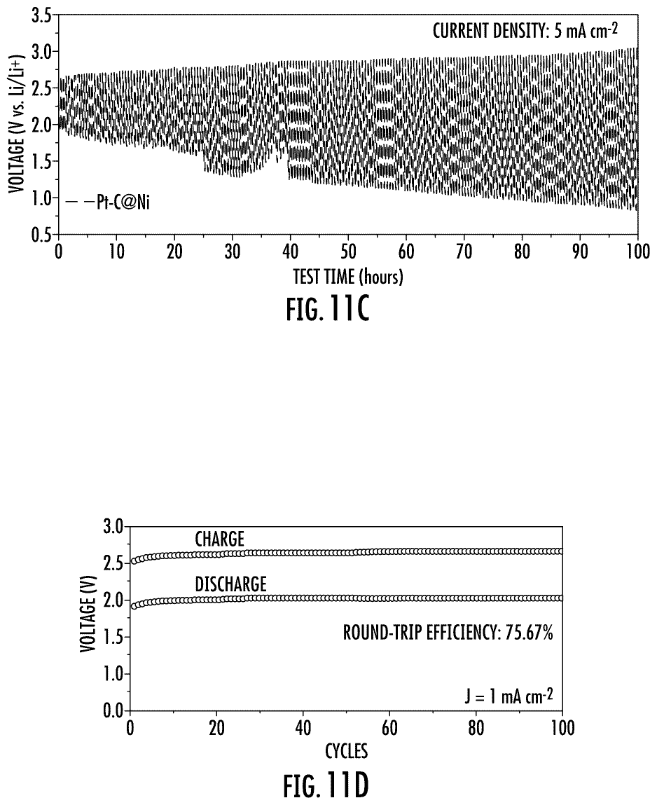

The Nb-SA@TiN—Ni electrode based DZAB also demonstrates outstanding rechargeability, as shown in FIG. 11A. The battery maintained stable operation for 600 cycles over 300 h (2 cycles per hour) with a consistently lower overpotential than that of the commercial Pt—C catalyst (FIG. 11B). It verified that Nb-based ASC on TiN—Ni electrode is stable even in strong acid OER process. To further assess the effect of the TiN coating, the cycling behavior of DZABs employing pristine Ni foam loaded with Pt—C as the air cathode was also examined, which exhibited a pronounced increase in voltage gap over time due to corrosion and catalyst detachment (FIG. 11C.) In contrast, the Nb-SA@TiN—Ni electrode retained stable discharge and charge voltages for nearly 300 h of continuous operation (FIG. 11A). Its η_{V5}, defined as the ratio of discharge to charge voltage at 5 mA cm⁻², was 72% initially, and remained at 69% after 600 cycles (equivalent to 300 h), indicating excellent long-term stability. Throughout cycling, the overpotential consistently remained below 0.88 V, with the charge voltage not exceeding 2.85 V. These results collectively confirm the superior durability and electrochemical reversibility of the Nb-SA@TiN—Ni air electrode, underscoring its potential as a robust and efficient cathode for high-voltage zinc-air batteries.

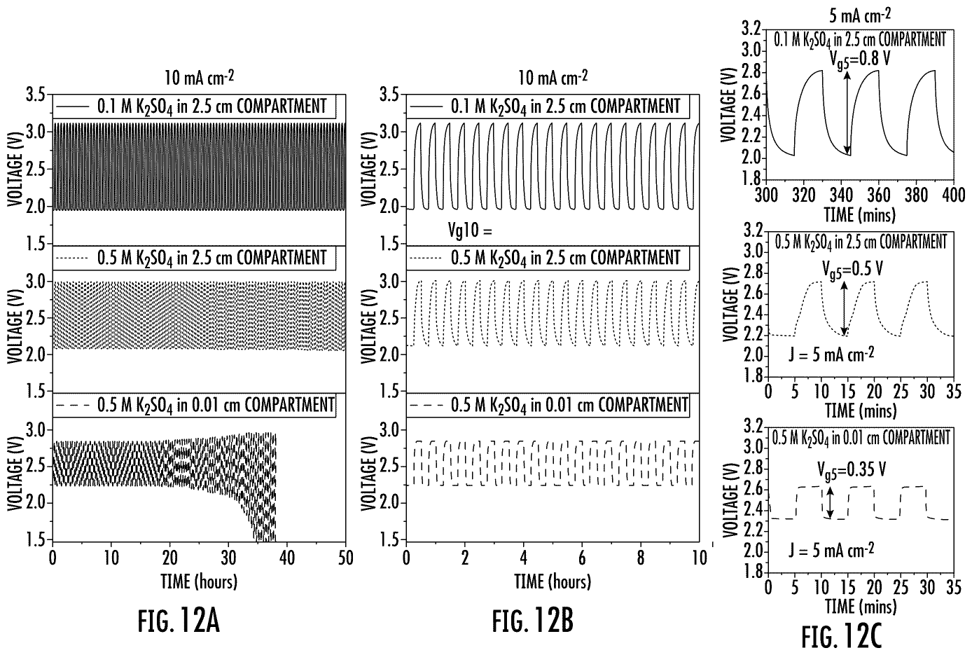

In a decoupling design comprising a CEM|Buffer|AEM (CBA) structure, the buffer electrolyte resistance is a significant issue since it will increase the charge-discharge voltage gap. FIG. 12 compares the chare-discharge cycling of DZABs with three K₂SO₄ buffers: 0.1 M and buffer compartment length 2.5 cm, 0.5 M and buffer compartment length 2.5 cm, and 0.5 M soaked in 0.01 cm thick glass fiber membrane. The Nb-SA@TiN—Ni air cathode is the same as that in FIG. 10. In FIGS. 12A and B, the three cells are cycled at 10 mA cm⁻². With reduction of the decoupling buffer resistance, the three cells exhibit a 10 mA cm⁻² charge and discharge voltage gap V_{g10} of 1.16V, 0.88V, and 0.60V, with roundtrip η_{V10} of 63%, 70% and 79% respectively. When cycled at 5 mA cm⁻², the three types of cells exhibited V_{g5} of 0.8V, 0.5 V and 0.35 V, and the roundtrip η_{V5} of 72%, 81%, and 87% respectively. The higher η_{V5} of 87% for the cell with 0.5 M K₂SO₄ buffers soaked in 0.01 cm thick glass is the result of the much smaller buffer resistance. However, due to the tiny volume of the buffer electrolyte, the cell has a shorter lifetime.

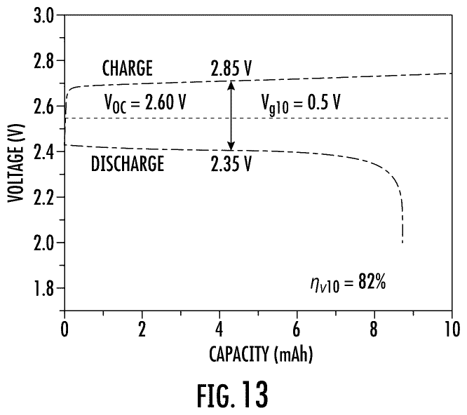

The data in FIGS. 12A-12C for DZABs with three different decoupling buffer designs indicate that optimization of buffer design is important. As aforementioned, in addition to the internal resistance, significant ORR and OER overpotentials play dominant roles in the large charge-discharge voltage gap (Vg) of ZABs. The large Vg in ZABs may be primarily due to high kinetic barriers associated with ORR and OER. ASC catalysts disclosed herein may increase kinetic activity and are configured to catalyze one or both of oxygen reduction reactions (ORR) and oxygen evolution reactions (OER) in acidic electrolytes as well as improved functioning in alkaline electrolytes. Effective bifunctional catalysts, disposed at a high loading, are needed to minimize activation overpotential and accelerate the reaction rates. FIG. 13 schematically depicts how the use of multi metal atomic scale catalysts may increase efficiency of ORR/OER, thereby reducing Vg₁₀ (the gap voltage at 10 mA cm⁻²) to 0.5 V and increasing efficiency of the decoupled ZAB cell to greater than 80%.

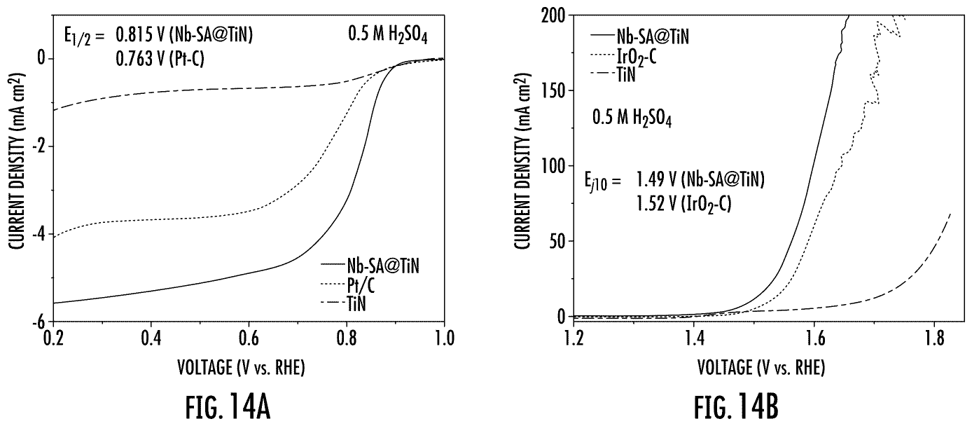

Furthermore, the large difference between η_{V5} and η_{V10} also suggests that high loading of OER/ORR bifunctional catalysts, in addition to their high catalytic activities are essential for highly efficient batteries. The ORR/OER performance of the disclosed Nb-based ASC on TiN substrate was evaluated using linear sweep voltammetry (LSV) in an acidic environment of 0.5 M H₂SO₄ with a rotating disk electrode (RDE), as shown in FIGS. 14A-14B, in comparison to Pt/C catalyst. As shown in FIG. 14A, for ORR, the Nb/TIN ASC exhibits a higher half-wave potential (E_{1/2}) of 0.815 V, surpassing the commercial Pt/C (0.763V). For OER, as depicted in FIG. 14B, the Nb/TIN ASC demonstrates a lower (better) potential at 10 mA/cm² (Eⱼ₌₁₀) of 1.49 V, outperforming the commercial IrO₂/C (1.52V).

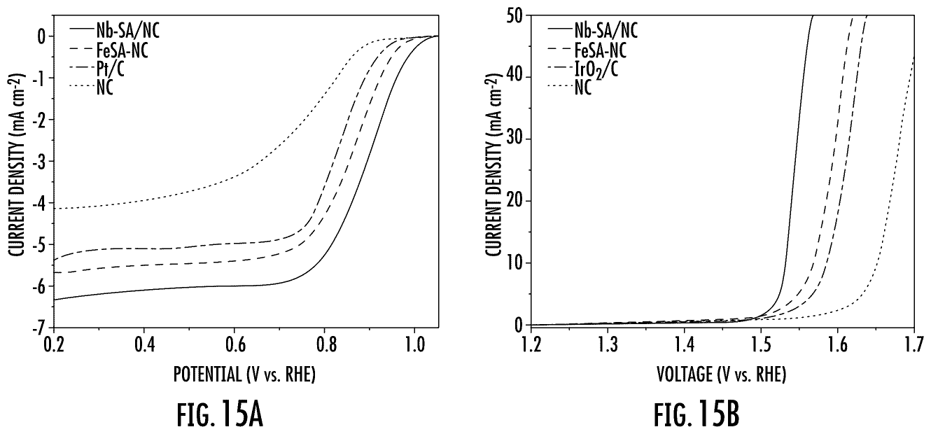

The ORR/OER performance of the disclosed ASC catalysts was extensively evaluated using linear sweep voltammetry (LSV) in an alkaline environment of 0.1 M KOH with a rotating disk electrode (RDE), as shown in FIGS. 15A-15B. As shown in FIG. 15A, for ORR, the Nb ASC exhibits the highest half-wave potential (E_{1/2}) of 0.89 V, surpassing the commercial Pt/C (benchmark). For OER, as depicted in FIG. 15B, the Nb ASC demonstrates the lowest potential at 10 mA/cm² (Eⱼ₌₁₀) of 1.54 V, outperforming the commercial IrO₂/C (benchmark).

The potential gap (ΔE=Eⱼ₌₁₀−E_{1/2}) serves as a measure of bifunctional catalytic performance, with smaller values indicating lower V_{g}. The Nb ASC achieves the lowest value of ΔE, of 0.65 V, outperforming the mixed Pt/C+IrO₂/C benchmark (0.72 V), highlighting its exceptional bifunctional catalytic activity for ORR and OER in alkaline media.

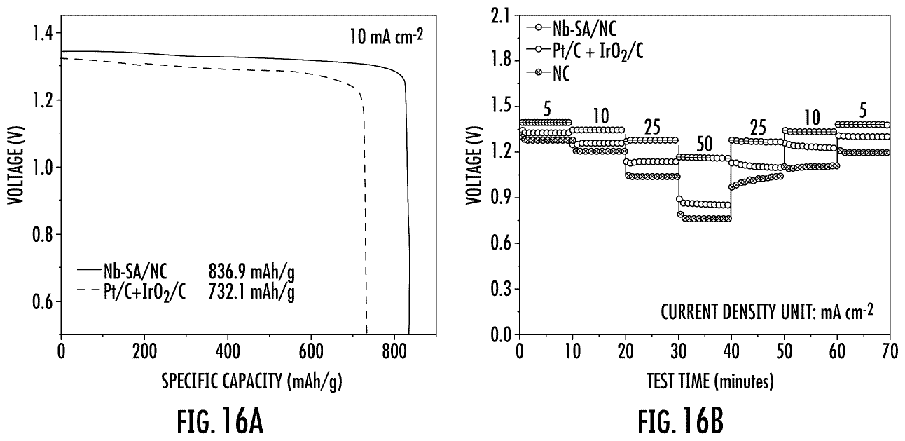

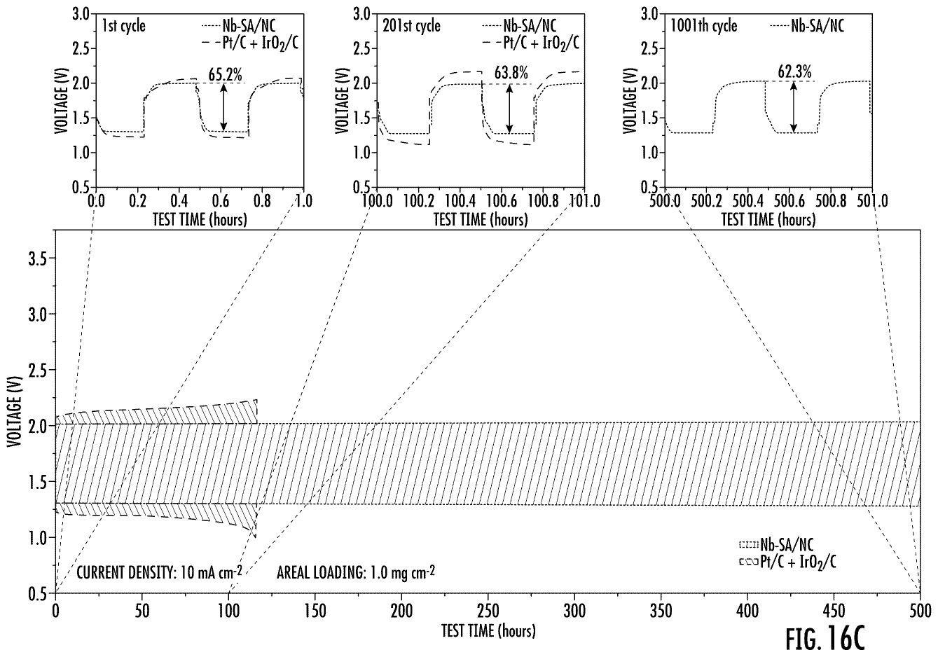

Using Nb ASC as a bifunctional catalyst on the disclosed air electrode contributes to improved performance in conventional, alkaline ZABs. As shown by FIG. 16A, a ZAB cell having an air electrode comprising Nb ASC achieves a 15% larger specific capacity than the PGM (Pt/C+IrO₂/C) cell at 10 mA cm⁻². As seen in FIG. 16B, a ZAB cell having an air electrode comprising Nb ASC maintains a high voltage of 1.2 V even at a high current density of 50 mA cm⁻², demonstrating excellent rate capability. As illustrated in FIG. 16C, a ZAB cell having an air electrode comprising Nb ASC exhibits exceptional cycling stability, remaining operational after 1000 charge/discharge cycles over 500 hours. Voltage efficiency shows minimal degradation, decreasing from 65.2% in the first cycle to 62.3% in the 1001st cycle, underscoring the durability of the Nb ASC catalyst. ZAB cells having an air electrode comprising Nb ASC as disclosed herein may serve as a more sustainable alternative to traditional PGM-based catalysts for long-term ZAB applications.

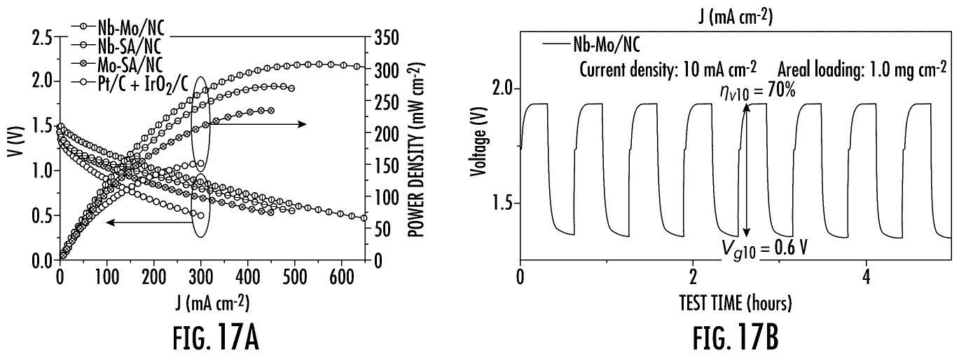

Further improvements to ZAB applications may be realized by incorporating Nb—Mo dual metal centers as part of the ASC, to further regulate the metal electronic structure. As shown in FIG. 17A, the ZAB cell comprising an ASC of Nb—Mo in an alkaline environment achieves a maximum power density of 310 mW cm⁻², which is among the highest values currently reported. For comparison, the PGM cell achieves around 155 mW cm⁻². FIG. 17B illustrates charge-discharge results of an alkaline ZAB cell comprising an ASC of Nb—Mo. The Nb—Mo cell shows a voltage efficiency (η_{V10}) of 70% as seen in FIG. 17B for an alkaline environment. ZAB cells having an air electrode comprising Nb—Mo ASC display a reduction in V_{g10}, from 0.9V (FIG. 2) to 0.6 V (FIG. 17B) in an alkaline environment. With improvements in ASC to reduce activation overpotential, in conjunction with minimizing ohmic and concentration overpotentials as discussed following, further reduction of V_{g10} to ~0.5 V in DZABs is achievable. The results of FIGS. 16-17 and others show that non-PGM ASCs, especially those with Nb and Mo metal centers, offer substantial benefits over traditional PGM-based catalysts in terms of capacity and durability.

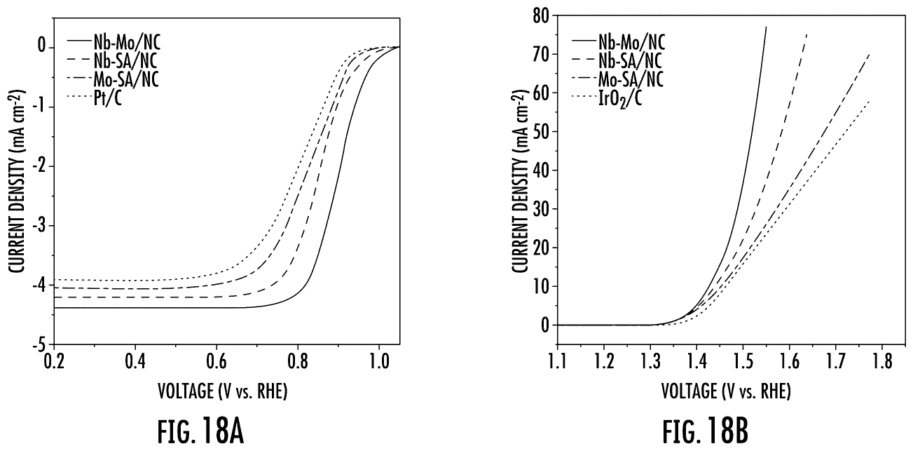

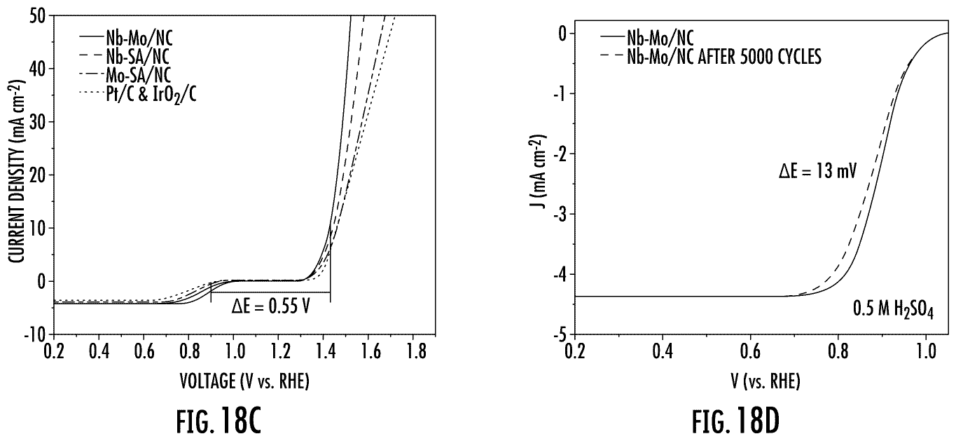

The acidic ORR/OER performance of the Nb and Mo catalysts was evaluated in H₂SO₄, as shown in FIGS. 18A-18D. According to FIG. 18A, among the tested catalysts, Nb—Mo ASC exhibits preferred performance for catalyzing ORR. As shown by FIG. 18B, Nb—Mo ASC also shows the highest catalytic activity for OER under acidic conditions. FIG. 18C illustrates a low potential gap (ΔE=Eⱼ₌₁₀−E_{1/2}) of 0.55 V for the disclosed, bifunctional ORR/OER catalyst comprising Nb—Mo ASC in an acidic environment. The low potential gap indicates the effectiveness of the catalyst comprising Nb—Mo ASC as a bifunctional ORR/OER catalyst. As shown by FIG. 18D, the Nb—Mo ASC displays reasonable stability in acidic conditions, with a 13 mV shift in ORR half-wave potential (E_{1/2}) after 5000 CV cycles, comparable to the stability of the Pt/C benchmark. Their stability may be further improved by coating with nanometer-thick TiN as a protection coating to enhance acid resistance or tolerance. These findings suggest that catalysts comprising Nb—Mo ASC have the potential to serve as non-PGM bifunctional catalysts for ORR/OER in acidic electrolytes.

The ORR/OER catalysts as disclosed herein have potential applications in reversible fuel cells and water electrolyzers, creating broad impacts across energy storage, hydrogen production, and sustainable development.

Other approaches beyond that of ORR/OER performance to reduce the large charge-discharge voltage gap (Vg) of conventional ZABs may address several factors, such as ohmic overpotential, which arises from resistive losses in the cell, including the resistance of the electrolyte, the electrodes, and the electrical connections, as well as any resistance to ion transport by the AEM and CEM. The AEM and CEM membranes of the DZAB as disclosed herein may be selected to minimize resistance to ion transport and reduce ohmic overpotential. Concentration overpotentials in conventional ZABs may arise when the transport of reactants is insufficient, leading to concentration gradients near the electrode surface. This is particularly true for the air electrode in conventional ZABs, where any or all of poor oxygen diffusion to or away from the catalyst, the “bubble effect”, and clogging of the GDL can increase overpotential. Concentration overpotential may be minimized at the new air electrode of the DZAB through incorporation of the air electrode structure and design, as disclosed herein. Through the use of more efficient catalysts for ORR and OER as disclosed herein, thereby reducing the charge-discharge voltage gap (V_{g10}) at a current density of 10 mA cm⁻², Vg₁₀ may be reduced from approximately 0.9 V as shown in FIGS. 4, to 0.5 V, as shown in FIGS. 12 and 13. By increasing the theoretical V_{OC} from 1.65 V to 2.60 V and reducing V_{g10} to 0.5 V, the efficiency, η_{V10} may be increased to 82%, a significant improvement over the efficiency of conventional, alkaline ZAB cells of less than 60%.

The aqueous, decoupled ZAB as disclosed herein, having an air electrode comprising atomic scale catalysts, provides a combination of an increased Voc and reduced V_{g10} which increases the efficiency, η_{V10}, to more than 82% from an efficiency of less than 60% for conventional, alkaline ZABs. The combination of high efficiency and non-PGM catalysts positions this technology as a game-changer in sustainable, large-scale energy storage, supporting grid stability and renewable energy integration with minimal environmental impact.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

Many additional implementations are possible. Further implementations are within the CLAIMS.

It will be understood that implementations of the preceding disclosure include but are not limited to the specific components disclosed herein, as virtually any components consistent with the intended operation may be utilized. Accordingly, for example, it should be understood that, while the drawings and accompanying text show and describe particular implementations, any such implementation may comprise any shape, size, style, type, model, version, class, grade, measurement, concentration, material, weight, quantity, and/or the like consistent with the intended operation.

The concepts disclosed herein are not limited to the specific embodiments shown herein. For example, it is specifically contemplated that the components included in particular embodiments may be formed of any of many different types of materials or combinations that can readily be formed into shaped objects and that are consistent with the intended operation of the disclosure. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, embodiments of the present disclosure may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular implementations, it should be readily apparent that a number of modifications may be made without departing from the spirit thereof and that these implementations may be applied to other implementations disclosed or undisclosed. The presently disclosed are, therefore, to be considered in all respects as illustrative and not restrictive.

What is claimed is:

1. A decoupled zinc air battery, the battery comprising:
an anode comprising zinc or a zinc-containing composite;
an alkaline anolyte fluidly coupled to the anode;
an air cathode, the air cathode comprising at least one atomic scale catalyst (ASC) dispersed on a titanium-based support, wherein the at least one ASC is configured to catalyze one or both of oxygen reduction reactions (ORR) and oxygen evolution reactions (OER);
an acidic catholyte fluidly coupled to the air cathode; and
a decoupling structure disposed between the alkaline anolyte and the acidic catholyte, wherein the anode and the air cathode are decoupled from one another.

2. The decoupled zinc air battery of claim 1, wherein the decoupling structure comprises a bipolar membrane (BPM) having an anion exchange membrane (AEM) fluidly coupled to the alkaline anolyte, a proton exchange membrane (PEM) fluidly coupled to the acidic catholyte, and a catalyst disposed between and fluidly coupled to the AEM and the PEM.

3. The decoupled zinc air battery of claim 1, wherein the decoupling structure comprises a cation exchange membrane (CEM) fluidly coupled to the alkaline anolyte, an anion exchange membrane (AEM) fluidly coupled to the acidic catholyte, and a neutral aqueous electrolyte between and fluidly coupled to the CEM and the AEM.

4. The decoupled zinc air battery of claim 1, wherein the at least one ASC comprises niobium (Nb), molybdenum (Mo), titanium (Ti), vanadium (V), iron (Fe), or nickel.

5. The decoupled zinc air battery of claim 1, wherein the titanium-based support comprises a titanium foam.

6. The decoupled zinc air battery of claim 1, wherein the titanium-based support comprises a titanium nitride (TiN) coating.

7. The decoupled zinc air battery of claim 1, wherein the decoupling structure comprises an anion exchange membrane (AEM) and a cation exchange membrane (CEM).

8. The decoupled zinc air battery of claim 3, wherein the neutral aqueous electrolyte comprises K₂SO₄.

9. The decoupled zinc air battery of claim 6, wherein the air cathode further comprises a gas diffusion layer (GDL) disposed over the titanium nitride coating.

10. A decoupled zinc air battery, the battery comprising:
an anode comprising zinc;
an alkaline anolyte fluidly coupled to the anode;
an air cathode, the air cathode comprising at least one atomic scale catalyst (ASC) formed on a nitrogen-doped carbon (NC) or polymeric carbon nitride (PCN) support, wherein the NC or PCN support is powder, wherein the powder is coated on an acid-tolerant conductive porous structure, and wherein the at least one ASC is configured to catalyze one or both of oxygen reduction reactions (ORR) and oxygen evolution reactions (OER);
an acidic catholyte fluidly coupled to the air cathode; and
a decoupling structure disposed between the alkaline anolyte and the acidic catholyte, wherein the anode and the air cathode are decoupled from one another.

11. The decoupled zinc air battery of claim 1, wherein the at least one atomic scale catalyst (ASC) comprises single atoms, clusters of atoms, or combinations thereof.

12. The decoupled zinc air battery of claim 1, wherein the titanium-based support comprises a TiN layer disposed between the titanium-based support and the at least one atomic scale catalyst.

13. The decoupled zinc air battery of claim 10, wherein the air cathode is further coated with nanometer-scale TiN coating.

14. A method of making a decoupled zinc-air battery, the method comprising:
providing an anode comprising zinc or a zinc-containing composite;
providing an alkaline anolyte and fluidly coupling it to the anode;
preparing an air cathode by:
depositing a titanium nitride (TiN) layer onto a nickel foam substrate; and
anchoring at least one atomic scale catalyst (ASC) comprising a transition metal selected from niobium (Nb), molybdenum (Mo), titanium (Ti), vanadium (V), iron (Fe), or nickel onto the TiN-coated substrate by impregnation and thermal treatment;
providing an acidic catholyte and fluidly coupling it to the air cathode;
disposing a decoupling structure between the alkaline anolyte and the acidic catholyte, wherein the decoupling structure comprises at least one ion exchange membrane selected from a bipolar membrane (BPM), a cation exchange membrane (CEM), or an anion exchange membrane (AEM);
assembling the battery such that the anode and air cathode are decoupled from one another by the decoupling structure.

15. The method of claim 14, wherein the titanium nitride (TiN) layer is deposited onto the nickel foam substrate by plasma-enhanced atomic layer deposition (PE-ALD).

16. The method of claim 14, wherein the atomic scale catalyst (ASC) comprises niobium single atoms anchored onto the TiN-coated substrate.

17. The method of claim 14, wherein the impregnation and thermal treatment step comprises annealing the TiN-coated substrate with the metal precursor at a temperature between 200° C. and 650° C.

18. The method of claim 14, wherein the decoupling structure comprises a bipolar membrane (BPM) having an anion exchange membrane (AEM) and a proton exchange membrane (PEM) with a catalyst layer disposed between them.

19. The method of claim 14, wherein the decoupling structure comprises a cation exchange membrane (CEM), an anion exchange membrane (AEM), and a neutral aqueous electrolyte comprising potassium sulfate (K₂SO₄) disposed between the CEM and AEM.

20. The method of claim 14, further comprising the step of coating the air cathode with a gas diffusion layer (GDL) disposed over the titanium nitride coating.
